(19) United States
(12) Patent Application Publication
(10) Pub. No.: US 2015/0127647 A1
(43) Pub. Date: May 7, 2015

(54) ELEMENT COMPUTATION-COMMUNICATION PARALLELIZATION METHOD IMPLEMENTED ON CUBED-SPHERE GRIDS BASED ON SPECTRAL ELEMENT METHOD AND HARDWARE DEVICE PERFORMING THE SAME

(71) Applicant: Korea Institute of Atmospheric Prediction Systems, Seoul (KR)

(72) Inventors: Ki-Hwan KIM, Seoul (KR); Jung-Han KIM, Seoul (KR); Seol-Eun SHIN, Seoul (KR); In-Sun SONG, Seoul (KR)

(21) Appl. No.: 14/080,072

(22) Filed: Nov. 14, 2013

(30) Foreign Application Priority Data
Nov. 7, 2013 (KR) 10-2013-0134661

(51) Int. Cl. G06F 17/30

(52) U.S. Cl. CPC G06F 17/30598
USPC 707/737

(57) ABSTRACT

A method of parallelizing computation in an element and communication between elements in a cubed-sphere coordinates system based on a spectral element method is disclosed. The method is performed in a hardware device including a computation part, a memory and a communication buffer. A first grid value at a first grid point in a first element among elements within group of a first group is computed according to a predetermined numerical equation substantially at the same time as a second grid value at a second grid point in a second element of the first group is sent to or received from the communication buffer.

### TECHNICAL FIELD

Example embodiments of the invention relate to a computation method for a numerical weather prediction model and a hardware device performing the same. More particularly, example embodiments of the invention relate to an element computation-communication parallelization method implemented on cubed-sphere grids based on a spectral element method and a hardware device performing the same.

### DESCRIPTION OF THE RELATED ART

A numerical weather prediction (“NWP”) model is a mathematical model to compute a plurality of equations including dynamic equations and physical parameterization equations of atmosphere and ocean in order to predict a future weather condition from current or past weather conditions. The NWP model may include a dynamic core part which is important to compute the dynamic equations. The dynamic core part may describe physical quantities such as, e.g., wind, temperature, pressure, humidity, entropy, etc. as primitive equations including a plurality of partial differential equations. The dynamic core part may numerically solve a solution of the primitive equations.

A computation method for the partial differential equations may be required to compute the primitive equations as well as information on positions of variables in the primitive equations. The information on positions of variables in the primitive equations may be acquired using a spherical coordinates system to indicate horizontal and vertical positions on the Earth. For example, a conventional latitude-longitude coordinates system may be used to indicate horizontal positions of the variables. Also, a vertical coordinates system such as, e.g., a pressure height, or a sea surface height may be used to indicate vertical positions of the variables.

The computation method for the partial differential equations may include a spectral element method. The spectral element method may divide a whole computational space into a plurality of element spaces, expand Legendre polynomials or Lagrange polynomials in each of the element spaces, and compute a numerical solution of the partial differential equations.

Technologies have been developed to use a cubed-sphere grid system to compute the numerical solution of the partial differential equations. The cubed-sphere grid system may reduce a difference between grid point distribution in a polar region and that in an equatorial region. If the NWP model uses the cubed-sphere grid system based on the spectral element method, a computation within an element space and a communication between element spaces adjacent to each other may be performed using a message passing interface (“MPI”) computation-communication method.

### CONTENT OF THE INVENTION

### Technical Object of the Invention

One or more example embodiment of the invention provides an element computation-communication parallelization method implemented on cubed-sphere grids based on a spectral element method capable of reducing a processing time to compute and communicate elements of the spectral element method.

Also, another example embodiment of the invention provides a hardware device performing the element computation-communication parallelization method implemented on cubed-sphere grids based on a spectral element method.

### Construction and Operation of the Invention

In an example embodiment of an element computation-communication parallelization method implemented on cubed-sphere grids based on a spectral element method, a plurality of elements are categorized into one of a first group and a second group. The second group communicates with the first group. The elements in the first group and the second group are categorized into one of an element within group and an element at group boundary. The element at group boundary communicates with one of the elements in the other group to which the element at group boundary does not belong. A first grid value at a first grid point in a first element among elements within group of the first group is computed according to a predetermined numerical equation. Both of a second grid value at a second grid point in a second element and a third grid value at a third grid point in a third element are send to or received from the communication buffer. The second element is among elements at group boundary of the first group. The third element is among elements at group boundary of the second group. The computation of the first grid value at the first grid point in the first element is performed substantially at the same time as the sending or receiving both of the second grid value at the second grid point in the second element and the third grid value at the third grid point in the third element.

In an example embodiment, the elements at group boundary of the first group may have a sequential order in a clockwise or counterclockwise direction on a cubed-sphere.

In an example embodiment, at least one of the second grid value and the third grid value may correspond to a first buffer index of the communication buffer by a predetermined look-up table.

In an example embodiment, grid values at boundary points in the elements at group boundary of the first group communicating with the second group may correspond to consecutive buffer indices of the communication buffer in a clockwise or counterclockwise direction on a cubed-sphere.

In an example embodiment, the second element may include a first boundary point having at least two grid values.

In an example embodiment, the first boundary point of the second element may correspond to a second buffer index of the communication buffer by a predetermined look-up table. The second buffer index may refer to the at least two grid values.

In an example embodiment of a hardware device performing an element computation-communication parallelization method implemented on cubed-sphere grids based on a spectral element method, the hardware device includes a computation part and a communication buffer. The computation part is configured to categorize a plurality of elements in a cubed-sphere coordinates system based on a spectral element method into one of a first group and a second group. The computation part is configured to categorize the elements in the first group and the second group into one of an element within group and an element at group boundary. The computation part is configured to compute a first grid value at a first grid point in a first element among elements within group of the first group according to a predetermined numerical equation. The second group communicates with the first group. The element at group boundary communicates with one of the elements in the other group to which the element at group boundary does not belong. The communication buffer is configured to send or receive both of a second grid value at a second grid point in a second element and a third grid value at a third grid point in a third element substantially at the same time as the computation part computes the first grid value at the first grid point in the first element. The second element is among elements at group boundary of the first group. The third element is among elements at group boundary of the second group.

In an example embodiment, the hardware device may further include a memory including a look-up table which stores a first buffer index of the communication buffer. The first buffer index may correspond to the second grid value or the third grid value.

In an example embodiment, the second element may include a first boundary point having at least two grid values.

In an example embodiment, the hardware device may further include a memory including a look-up table which stores a second buffer index of the communication buffer. The first boundary point of the second element may correspond to the second buffer index. The second buffer index may refer to the at least two grid values.

### Effect of the Invention

According to one or more example embodiment of the element computation-communication parallelization method implemented on cubed-sphere grids based on a spectral element method and the hardware device performing the same, the elements of the spectral element method may be categorized into elements within a group and elements at group boundary, and a computation of the elements within the group may be simultaneously performed with a communication between the elements at the group boundary thereby reducing a processing time to compute and communicate the elements of the spectral element method in cubed-sphere grids.

Also, the communication between the elements at the group boundary may be performed by using a predetermined look-up table, and a dimension of a communication buffer may be adequately adjusted, thereby reducing a computational complexity to apply a variety of dynamic conditions of the atmosphere without an additional parallelization information table.

### BRIEF EXPLANATION OF THE DRAWINGS

The above and other features and advantages of the invention will become more apparent by describing in detailed example embodiments thereof with reference to the accompanying drawings, in which:

FIG. 1 is a block diagram illustrating a hardware device performing an element computation-communication parallelization method implemented on cubed-sphere grids based on a spectral element method according to an example embodiment of the invention;

FIG. 2 is a perspective view illustrating a cubed-sphere coordinates system which may be used in the hardware device of FIG. 1;

FIG. 3 is a plan view conceptually illustrating grid boxes of the cubed-sphere coordinates system of FIG. 2;

FIG. 4 is an enlarged plan view illustrating GLL-points in a 7th element of FIG. 3;

FIG. 5 is an enlarged plan view illustrating GLL-points in elements adjacent to the 7th element of FIG. 4;

FIG. 6 is a plan view illustrating grid boxes of a cubed-sphere coordinates system based on a spectral element method according to another example embodiment of the invention;

FIG. 7 is a plan view illustrating a plurality of groups which categorizes elements of FIG. 6;

FIG. 8 is an enlarged plan view illustrating GLL-points in elements at group boundary of a 1st group and GLL-points in elements at group boundaries of another group adjacent to the 1st group of FIG. 7;

FIG. 9 is a block diagram illustrating a first look-up table with a communication buffer in a hardware device according to an example embodiment of the invention;

FIG. 10 is a block diagram illustrating an expansion of dimension of the communication buffer of FIG. 9;

FIG. 11 is a block diagram illustrating a second look-up table with a communication buffer in a hardware device according to an example embodiment of the invention;

FIG. 12 is a block diagram illustrating a multi-valued GLL-point in an element at group boundary and a third look-up table with a communication buffer in a hardware device according to an example embodiment of the invention;

FIG. 13 is a block diagram illustrating another multi-valued GLL-point in the element at group boundary and the third look-up table of FIG. 12;

FIG. 14 is a plan view illustrating elements categorized into two groups in an element computation-communication parallelization method implemented on cubed-sphere grids based on a spectral element method according to example embodiment of the invention;

FIG. 15 is a block diagram illustrating a buffer memory in a hardware device which may be used in the element computation-communication parallelization method of FIG. 14; and

FIG. 16 is a plan view illustrating multi-valued GLL-points with a fourth look-up table corresponding to the buffer memory of FIG. 15.

### DETAILED DESCRIPTION OF THE INVENTION

Various example embodiments will be described more fully hereinafter with reference to the accompanying drawings, in which example embodiments are shown. Example embodiments may, however, be embodied in many different forms and should not be construed as limited to example embodiments set forth herein. Rather, these example embodiments are provided so that this disclosure will be thorough and complete, and will fully convey the scope of example embodiments to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below.

The terminology used herein is for the purpose of describing particular example embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the invention will be described in further detail with reference to the accompanying drawings.

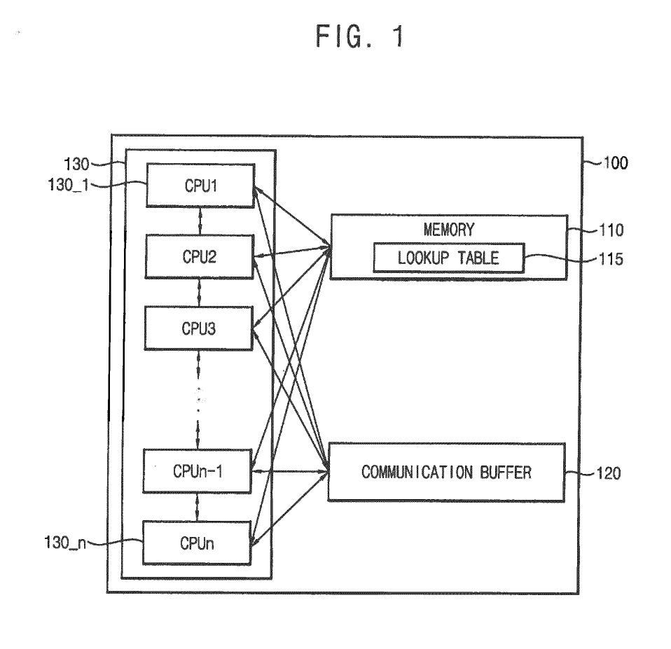

FIG. 1 is a block diagram illustrating a hardware device performing an element computation-communication parallelization method implemented on cubed-sphere grids based on a spectral element method according to an example embodiment of the invention.

Referring to FIG. 1, a hardware device 100 performing an element computation-communication parallelization method implemented on cubed-sphere grids based on a spectral element method according to the present example embodiment may include a memory 110, a communication buffer 120 and a computation part 130. For example, the hardware device 100 may include a server including a plurality of central processing units (CPUs) and a buffer memory. The memory 110 may include at least one look-up table (LUT) 115. The computation part 130 may include a plurality of CPUs (i.e., CPU1 to CPUn). For example, the computation part 130 may include a first CPU 103_1 to an n-th CPU 130_n configured to communicate with one another. For example, the computation part 130 may include thousands of or millions of CPUs. The memory 110, the look-up table 115, the communication buffer 120 and the communication part 130 may be electrically connected with one another. Although the communication buffer 120 is separated from the memory 110 in FIG. 1, the memory 110 and the communication buffer 120 may be integrated in a single memory space in another example embodiment.

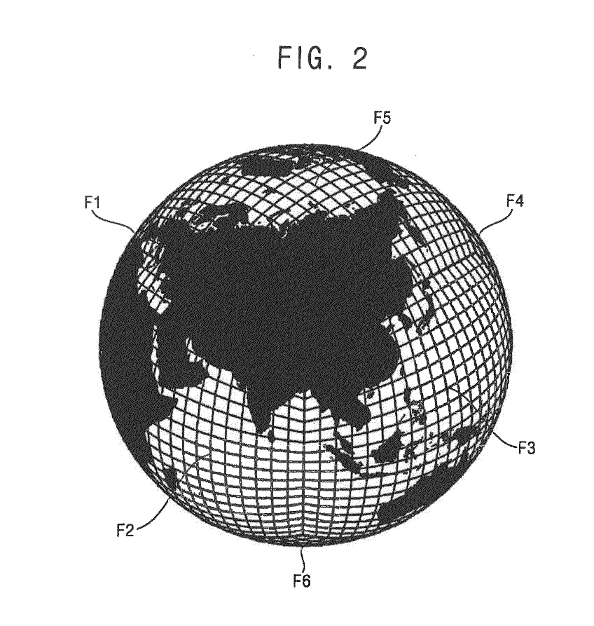

FIG. 2 is a perspective view illustrating a cubed-sphere coordinates system which may be used in the hardware device of FIG. 1.

Referring to FIG. 2, the hardware device 100 may implement a numerical weather prediction model using a cubed-sphere coordinates system instead of a conventional latitude-longitude coordinates system. The cubed-sphere coordinates system may include six faces on the Earth's surface. The cubed-sphere coordinates system may include a plurality of abscissa grid lines extending in a first direction and a plurality of ordinate grid lines extending in a second direction which crosses the first direction in each face of the six faces. The first direction may be substantially perpendicular to the second direction on a virtual face of a regular cube within the Earth. For example, the cubed-sphere coordinates system may include a first face F1 in which an intersection point of an equator and a prime meridian is centered. The cubed-sphere coordinates system may include a second face F2, a third face F3 and a fourth face F4 sequentially disposed adjacent to the first face F1 according to a rotational direction of the Earth. The cubed-sphere coordinates system may include a fifth face F5 in which the North Pole NP is centered. The cubed-sphere coordinates system may include a sixth face F6 in which the South Pole SP is centered. Each of the faces may have a convex shape inflated from the regular cube. If the numerical weather prediction model uses the cubed-sphere coordinates system to represent physical parameters of the atmosphere and/or the ocean, a difference of grid point resolution between a polar region and an equatorial region may be reduced while the difference of grid point resolution occurs in the latitude-longitude coordinates system due to a fine resolution in the polar region and a coarse resolution in the equatorial region. Also, intervals between grid points through the Earth's surface may be relatively uniform.

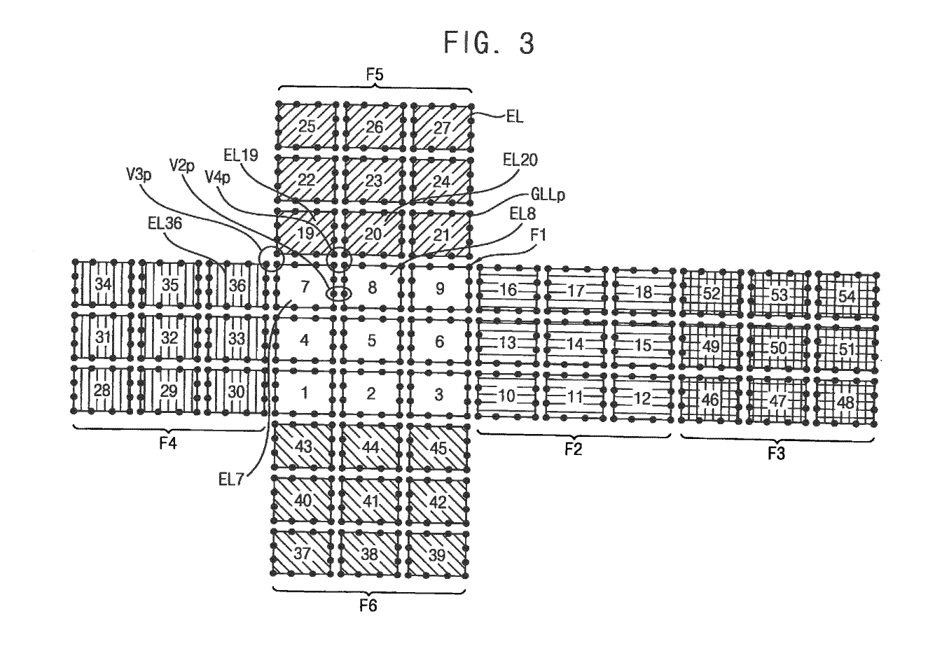

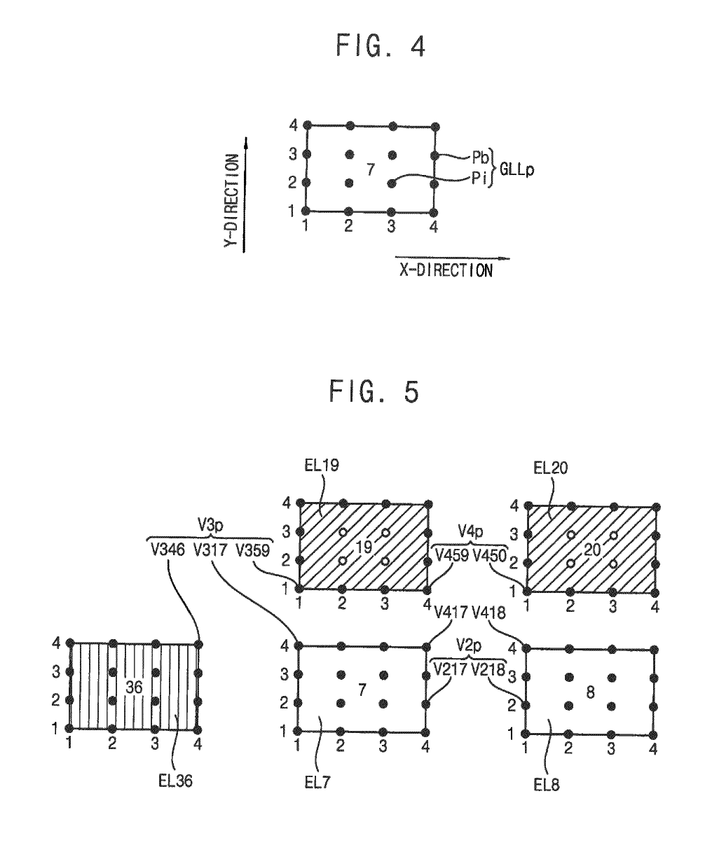

FIG. 3 is a plan view conceptually illustrating grid boxes of the cubed-sphere coordinates system of FIG. 2. FIG. 4 is an enlarged plan view illustrating GLL-points in a 7th element of FIG. 3. FIG. 5 is an enlarged plan view illustrating GLL-points in elements adjacent to the 7th element of FIG. 4.

Referring to FIG. 3, FIG. 4 and FIG. 5, each of the faces F1, F2, F3, F4, F5 and F6 may include a plurality of elements EL arranged in a substantially squared shape which has three elements EL in a side. For example, the faces F1, F2, F3, F4, F5 and F6 may include nine elements EL arranged in a 3×3 matrix shape respectively. The elements EL may have desired indices on a cubed-sphere. For example, the elements EL may have indices of 1 to 54 if each of the six faces F1, F2, F3, F4, F5 and F6 includes the nine elements EL. For example, the elements EL in the first face F1 may have indices of 1 to 9. For example, the elements EL in the second face F2 may have indices of 10 to 18. For example, the elements EL in the third face F3 may have indices of 46 to 54. For example, the elements EL in the fourth face F4 may have indices of 28 to 36. For example, the elements EL in the fifth face F5 may have indices of 19 to 27. For example, the elements EL in the sixth face F6 may have indices of 37 to 45. Also, the indices of the elements EL may have a desired sequence, e.g., a growing sequence from left to right or from bottom to top. For example, the elements EL in a bottom row of the first face F may have indices of 1 to 3 from left to right. The elements EL in a middle row of the first face F1 may have indices of 4 to 6 from left to right. The elements EL in a top row of the first face F1 may have indices of 7 to 9 from left to right.

Referring to FIG. 4, each of the elements EL may include a plurality of Gauss-Legendre-Lobatto points (hereinafter, “GLL-point”) GLLp. For example, each of the elements EL may include sixteen GLL-points GLLp arranged in a 4×4 matrix shape. For example, the GLL-points GLLp may correspond to grid points in the cubed-sphere coordinates system respectively. Alternatively, the GLL-points GLLp may be adjacent to the grid points in the cubed-sphere coordinates system respectively. Hereinafter, a value of a physical quantity at a GLL-point among the GLL-points GLLp may be referred as a grid value for ease of description. The GLL-points GLLp may be categorized into inner points Pi within each of the elements EL or boundary points Pb at each of the elements EL. The GLL-points may be indicated by coordinates of an abscissa, an ordinate and an element index in the cubed-sphere coordinates system. For example, an inner point Pi illustrated in FIG. 4 may be indicated by coordinates of (3, 2, 7). Also, a boundary point Pb illustrated in FIG. 4 may be indicated by coordinates of (4, 3, 7). It should be noted that only the boundary points Pb of the elements EL are illustrated in each of the elements EL in FIG. 3.

Although the elements EL are spaced apart from one another in FIG. 3 and FIG. 5, each of the elements EL may share its boundary points Pb with adjacent elements EL in an actual computation of a spectral element method. For example, although two GLL-points GLLp are illustrated at a border between a 7th element EL7 and an 8th element EL8 of the first face F1 in FIG. 3, the two GLL-points GLLp may be manipulated as a single GLL-point V2p which has two grid values in the computation of the spectral element method. Similarly, although three GLL-points GLLp are illustrated at a border between the 7th element EL7, a 36th element EL36 and a 19th element EL19 in FIG. 3, the three GLL-points GLLp may be manipulated as a single GLL-point V3p which has three grid values in the computation of the spectral element method. Similarly, although four GLL-points GLLp are illustrated at a border between the 7th element EL7, the 8th element ELS, a 19th element EL19 and a 20th element EL20 in FIG. 3, the four GLL-points GLLp may be manipulated as a single GLL-point V4p which has four grid values in the computation of the spectral element method. Hereinafter, a GLL-point GLLp which has a plurality of grid values is referred as a multi-valued GLL-point.

Referring to FIG. 5, the GLL-point V2p at the border between the 7th element EL7 and the 8th element EL8 may have both a first grid value V217 in the 7th element EL7 and a second grid value V218 in the 8th element EL8. The GLL-point V3p at the border between the 7th element EL7, the 19th element EL19 and the 36th element EL36 may have a third grid value V317 in the 7th element EL7, a fourth grid value V359 in the 19th element EL19 and a fifth grid value V346 in the 36th element EL36. The GLL-point V4p at the border between the 7th element EL7, the 8th element ELS, the 19th element EL19 and the 20th element EL20 may have a sixth grid value V417 in the 7th element EL7, a seventh grid value V418 in the 8th element EL8, an eighth grid value V459 in the 19th element EL19 and a ninth grid value V450 in the 20th element EL20. Each of the first grid value V217 through the ninth grid value V450 may be a scalar value (i.e., an array value having a zero dimension) or an array value having a desired dimension.

In the present example embodiment, grid values at inner points Pi and boundary points Pb on each of the elements EL may be computed in a dynamic core part. Then, the grid values at the boundary points Pb may be communicated with each other. The communication of the grid values at the boundary points Pb may be performed to satisfy continuity and flux transfer of the physical quantity of the atmosphere and/or the ocean. For example, referring to FIG. 5, grid values at the inner points and the boundary points having coordinates of (1, 1, 7), (1, 2, 7), (1, 3, 7), (1, 4, 7), (2, 1, 7), (2, 2, 7), (2, 3, 7), (2, 4, 7), (3, 1, 7), (3, 2, 7), (3, 3, 7), (3, 4, 7), (4, 1, 7), (4, 2, 7), (4, 3, 7) and (4, 4, 7) may be computed in the 7th element EL7. Then, the grid values at the boundary points having coordinates of (1, 1, 7), (1, 2, 7), (1, 3, 7), (1, 4, 7), (2, 1, 7), (2, 4, 7), (3, 1, 7), (3, 4, 7), (4, 1, 7), (4, 2, 7), (4, 3, 7) and (4, 4, 7) may be communicated with boundary points of elements EL adjacent to the 7th element EL7 by using the communication buffer 120. For example, the first grid value V217 at the boundary point having coordinates of (4, 2, 7) in the 7th element EL7 may be communicated with the second grid value V218 at a boundary point having coordinates of (1, 2, 8). For example, the first grid value V217 and the second grid value V218 may be sent to the communication buffer 120 or may be received from the communication buffer 120 by a desired communication protocol. Similarly, a computation of grid values in the elements EL and a communication between grid values at the boundary points Pb may be sequentially performed.

However, a running time to compute the grid values in all of the elements EL in a first time step may be relatively long in the hardware device 100. Accordingly, a start time to communicate the grid values at the boundary points Pb in the first time step may be delayed to wait for a completion of the computation of the grid values in all of the elements EL. Also, a start time to compute the grid values in all of the elements EL in a second time step which is subsequent to the first time step may be delayed to wait for a completion of the communication of the grid values at the boundary points Pb in the first time step.

Accordingly, a whole running time required to compute and communicate the grid values in the elements EL may increase, thereby reducing process efficiency in a numerical weather prediction model.

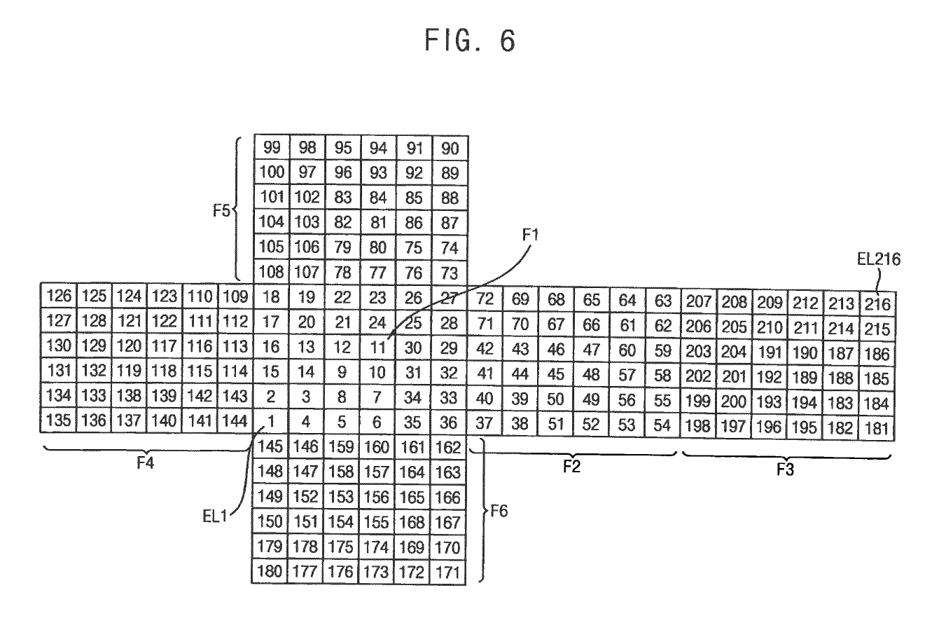

FIG. 6 is a plan view illustrating grid boxes of a cubed-sphere coordinates system based on a spectral element method according to another example embodiment of the invention.

Referring to FIG. 6, each of the faces F, F2, F3, F4, F5 and F6 may include a plurality of elements EL arranged in a substantially squared shape which has six elements EL in a side. For example, the faces F1, F2, F3, F4, F5 and F6 may include thirty-six elements EL arranged in a 6×6 matrix shape respectively. The elements EL may have desired indices on a cubed-sphere. For example, the elements EL may have indices of 1 to 216 if each of the six faces F1, F2, F3, F4, F5 and F6 includes the thirty-six elements EL. For example, the elements EL in the first face F1 may have indices of 1 to 36. For example, the elements EL in the second face F2 may have indices of 37 to 72. For example, the elements EL in the third face F3 may have indices of 181 to 216. For example, the elements EL in the fourth face F4 may have indices of 109 to 144. For example, the elements EL in the fifth face F5 may have indices of 73 to 108. For example, the elements EL in the sixth face F6 may have indices of 145 to 180.

The indices of the elements EL may be consecutive from element to element in the faces F1, F2, F3, F4, F5 and F6. For example, the indices of the elements EL may have a traversable network in the faces F1, F2, F3, F4, F5 and F6.

Although each of the faces F1, F2, F3, F4, F5 and F6 includes thirty-six elements in FIG. 6, a number of elements in the faces and a number of GLL-points in the elements may be various according to example embodiments. For example, the number of elements in each of the faces F1, F2, F3, F4, F5 and F6 may be 64 (=8×8), 81 (=9×9), etc.

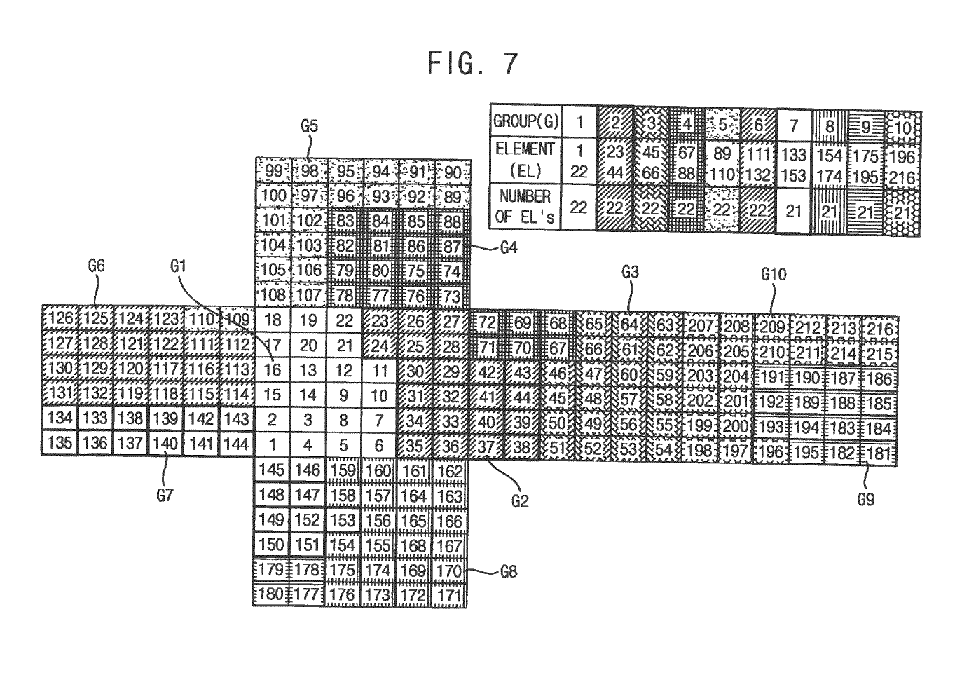

FIG. 7 is a plan view illustrating a plurality of groups which categorizes elements of FIG. 6.

Referring to FIG. 7, elements in the faces F1, F2, F3, F4, F5 and F6 may be categorized into a plurality of groups G. For example, the 216 elements in the cubed-sphere may be categorized into ten groups from a first group G1 to a tenth group G10. For example, the first group G1 may include twenty-two elements from a 1st element to a 22nd element. A second group G2 may include twenty-two elements from a 23rd element to a 44th element. Indices of the elements in a third group G3 through the tenth group G10 may be represented in a table illustrated at upper right in FIG. 7.

Each of the groups G may be within one of the faces or in a plurality of faces on the cubed-sphere. For example, the first group G1 may be entirely within the first face. The 25 second group G2 may be in the first face and the second face next to the first face. Similarly, a fifth group G5 may be in the fifth face and the fourth face next to the fifth face. Although GLL-points of each of the elements EL are omitted in FIG. 7, the elements EL may include a plurality of GLL-points, e.g., such as the GLL-points GLLp in FIG. 4 and FIG. 5. The number of the GLL-points may be various according to example embodiments. For example, the number of GLL-points in each of the elements EL may be 36 (=6×6), 49 (=7×7), etc.

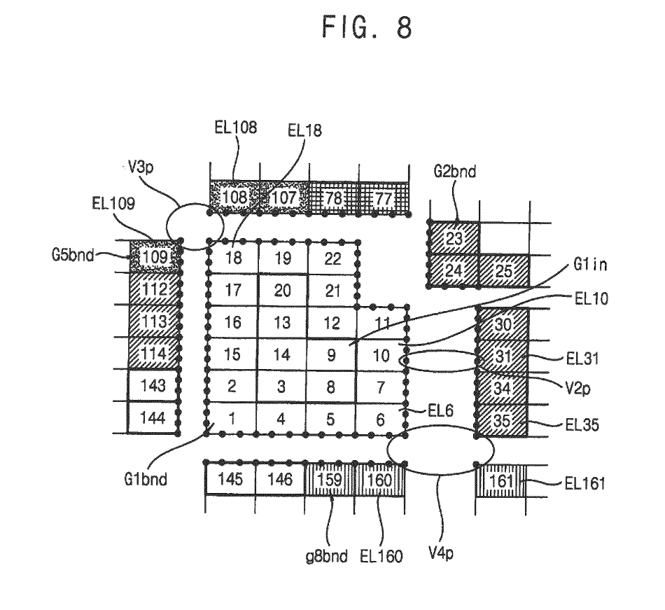

FIG. 8 is an enlarged plan view illustrating GLL-points in elements at group boundary of a 1st group and GLL-points in elements at group boundaries of another group adjacent to the 1st group of FIG. 7.

Referring to FIG. 8, elements in each of the groups G may be categorized into elements within a group or elements at group boundary. For example, a 3rd element, an 8th element, a 9th element, a 13th element, a 14th element and a 20th element in the first group G1 may be categorized into elements within a first group G1in. A 1st element, a 2nd element, a 4th element, a 5th element, a 6th element, a 7th element, a 10th element, a 11th element, a 12th element, a 15th element, a 16th element, a 17th element, a 18th element, a 19th element, a 21st element and a 22nd element may be categorized into elements at a first group boundary G1bnd.

Referring to FIG. 7 and FIG. 8, boundary points in the elements at the group boundary G1bnd of the first group G1 may be communicated with other boundary points in elements at group boundary of another group adjacent to the first group G1. For example, a boundary point having coordinates of (4, 2, 10) in the 10th element EL10 at the first group boundary G1bnd of the first group G1 may be communicated with a boundary point having coordinates of (1, 2, 31) in a 31st element EL31 at second group boundary G2bnd of the second group G2. In this case, the boundary point having coordinates of (4, 2, 10) in the 10th element EL10 and the boundary point having coordinates of (1, 2, 31) in the 31st element EL31 may be a multi-valued GLL-point V2p which has two grid values. Similarly, a boundary point having coordinates of (1, 4, 18) in the 18th element EL18 at the first group boundary G1bnd of the first group G1 may be communicated with both a boundary point having coordinates of (1, 1, 108) in a 108th element EL108 at fifth group boundary G5bnd of the fifth group G5 and a boundary point having coordinates of (4, 4, 109) in a 109th element EL109 at the fifth group boundary G5bnd of the fifth group G5. In this case, the boundary point having coordinates of (1, 4, 18) in the 18th element EL8, the boundary point having coordinates of (1, 1, 108) in the 108th element EL108 and the boundary point having coordinates of (4, 4, 109) in the 109th element EL109 may be a multi-valued GLL-point V3p which has three grid values. Similarly, a boundary point having coordinates of (4, 1, 6) in the 6th element EL6 at the first group boundary G1bnd of the first group G1 may be communicated with a boundary point having coordinates of (1, 1, 35) in a 35th element EL35 at the second group boundary G2bnd of the second group G2, a boundary point having coordinates of (4, 4, 160) in a 160th element EL160 at eighth group boundary G8bnd of the eighth group G8 and a boundary point having coordinates of (1, 4, 161) in a 161st element EL161 at the eighth group boundary G8bnd of the eighth group G8. In this case, the boundary point having coordinates of (4, 1, 6) in the 6th element EL6, the boundary point having coordinates of (1, 1, 35) in the 35th element EL35, the boundary point having coordinates of (4, 4, 160) in the 160th element EL160 and the boundary point having coordinates of (1, 4, 161) in the 161st element EL161 may be a multi-valued GLL-point V4p which has four grid values.

In the present example embodiment, grid values at GLL-points in elements at group boundary may be communicated with each other substantially at the same time as grid values at GLL-points in elements within groups are computed. For example, in a first time step, grid values at inner points and boundary points in elements within the first group G1in may be computed substantially at the same time as boundary points in elements at the first group boundary G1bnd of the first group G1 are communicated with boundary points in elements at group boundary of groups adjacent to the first group G1.

Accordingly, a running time to compute and communicate grid values in all of the elements EL in a first time step may decrease in the hardware device 100. Also, a process to compute and communicate grid values in the elements EL in a second time step which is subsequent to the first time step may start earlier than in a sequential process of computation and communication. Accordingly, a whole running time required to compute and communicate the grid values in the elements EL may decrease, thereby improving process efficiency in a numerical weather prediction model.

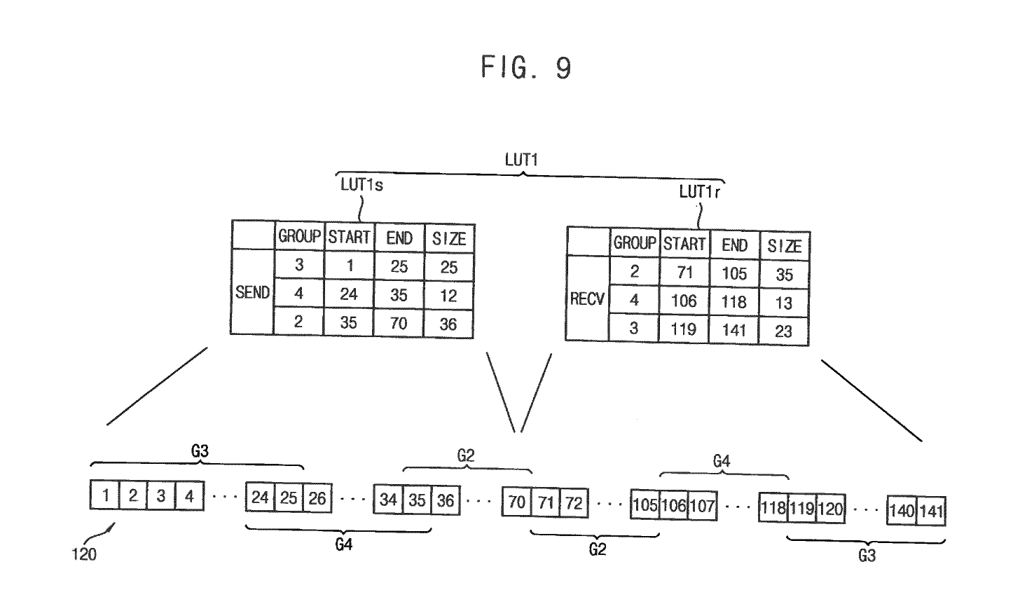

FIG. 9 is a block diagram illustrating a first look-up table with a communication buffer in a hardware device according to an example embodiment of the invention.

Referring to FIG. 7, FIG. 8 and FIG. 9, buffer indices of grid values which are sent to or received from each of the groups in a communication process between elements at group boundaries in FIG. 7 and FIG. 8 may be defined by a predetermined table in a memory. For example, a first look-up table LUT1 may include a first sending look-up table LUT1s and a first receiving look-up table LUT1r. The first sending look-up table LUT1s may be configured to store buffer indices of grid values sent to a 2nd group, a 3rd group and a 4th group. The first receiving look-up table LUT1r may be configured to store buffer indices of grid values received from the 2nd group, the 3rd group and the 4th group. For example, the first sending look-up table LUT1s may be configured to store number one through number twenty-five among buffer indices of a communication buffer 120 to send corresponding grid values to the 3rd group. The first sending look-up table LUT1s may be configured to store number twenty-four through number thirty-five among buffer indices of the communication buffer 120 to send corresponding grid values to the 4th group. The first sending look-up table LUT1s may be configured to store number thirty-five through number seventy among buffer indices of the communication buffer 120 to send corresponding grid values to the 2nd group. Similarly, the first receiving look-up table LUT1r may be configured to store number seventy-one through number one hundred and five among buffer indices of the communication buffer 120 to receive corresponding grid values from the 2nd group. The first receiving look-up table LUT1r may be configured to store number one hundred and six through number one hundred eighteen among buffer indices of the communication buffer 120 to receive corresponding grid values from the 4th group. The first receiving look-up table LUT1r may be configured to store number one hundred nineteen through number one hundred forty-one among buffer indices of the communication buffer 120 to receive corresponding grid values from the 3rd group.

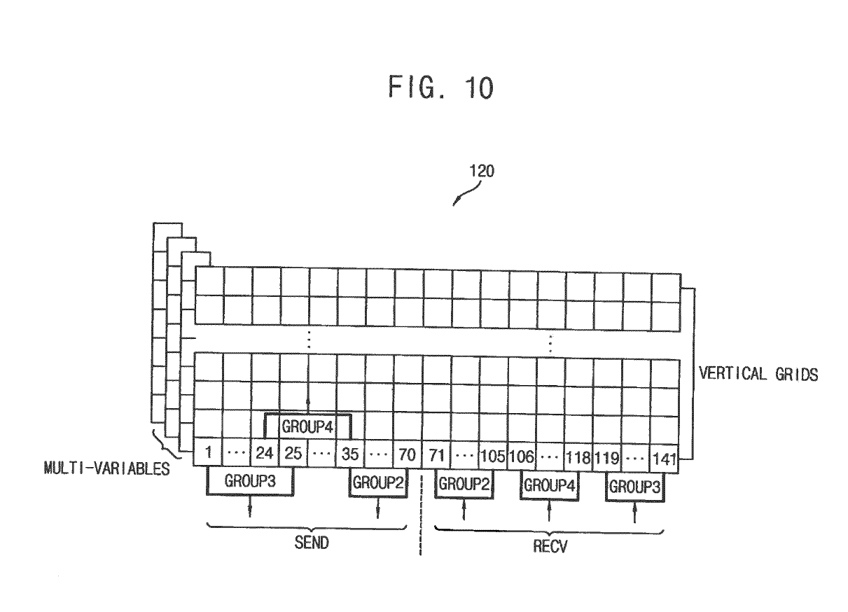

FIG. 10 is a block diagram illustrating an expansion of dimension of the communication buffer of FIG. 9.

Referring to FIG. 9 and FIG. 10, each of the grid values corresponding to the buffer indices sent to the communication buffer 120 or received from the communication buffer 120 by the first look-up table LUT1 in FIG. 9 may have a scalar value, an array value having a single dimension (e.g., with vertical coordinates), an array value having two dimensions (e.g., with multi-variables), etc. A format of each of the grid values may be adequately determined according to example embodiments.

As mentioned above, buffer indices for a communication process between grid values at elements at group boundaries may be stored in a look-up table, and the grid values at the elements at group boundaries may be sent to or received from a communication buffer using the look-up table thereby easily performing computation and communication of elements with manipulation of dimension of array without an additional parallelization Information table.

Also, the dimension of the array may be adequately modified in the communication buffer, thereby easily applying a variety of dynamic conditions, e.g., such as a two-dimensional shallow water model, a three-dimensional hydrostatic model, a three-dimensional non-hydrostatic model, etc. for a numerical weather prediction model.

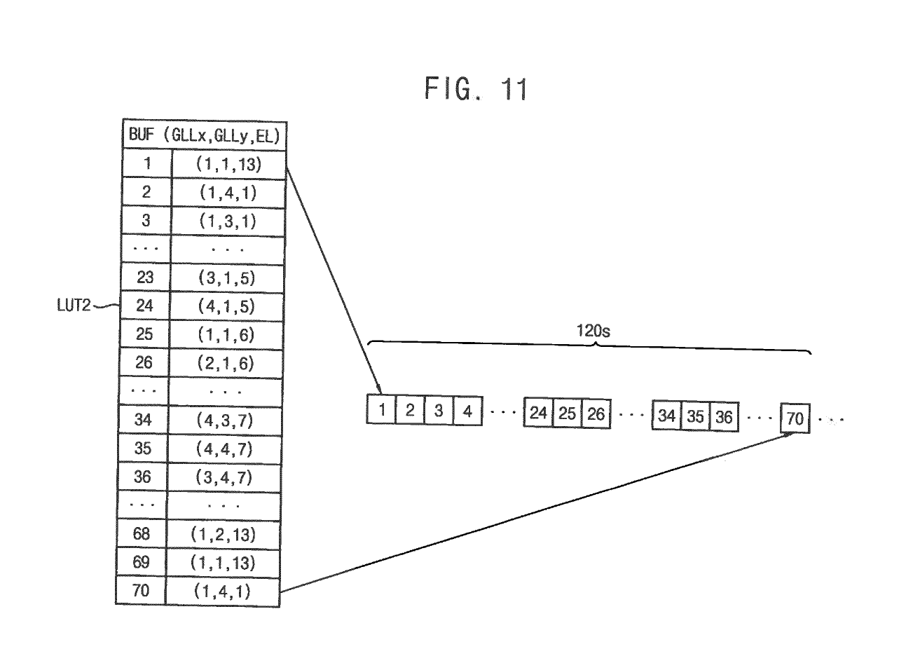

FIG. 11 is a block diagram illustrating a second look-up table with a communication buffer in a hardware device according to an example embodiment of the invention.

Referring to FIG. 11, a second look-up table LUT2 may be configured to store buffer indices of grid values which may be sent to GLL-points from a sending region 120s of a communication buffer. The buffer indices of grid values may correspond to the GLL-points in the second look-up table LUT2. For example, number one among the buffer indices in the sending region 120s of the communication buffer may correspond to a grid value at coordinates of (1, 1, 13) among GLL-points in a 13th element. For example, number seventy among the buffer indices in the sending region 120s of the communication buffer may correspond to a grid value at coordinates of (1, 4, 1) among GLL-points in a 1st element.

The first look-up table LUT1 in FIG. 9 and the second look-up table LUT2 in FIG. 11 may be used in a communication process between grid values at elements at group boundaries, thereby easily referring to buffer indices of a communication buffer in order to send or receive grid values in elements at the group boundaries.

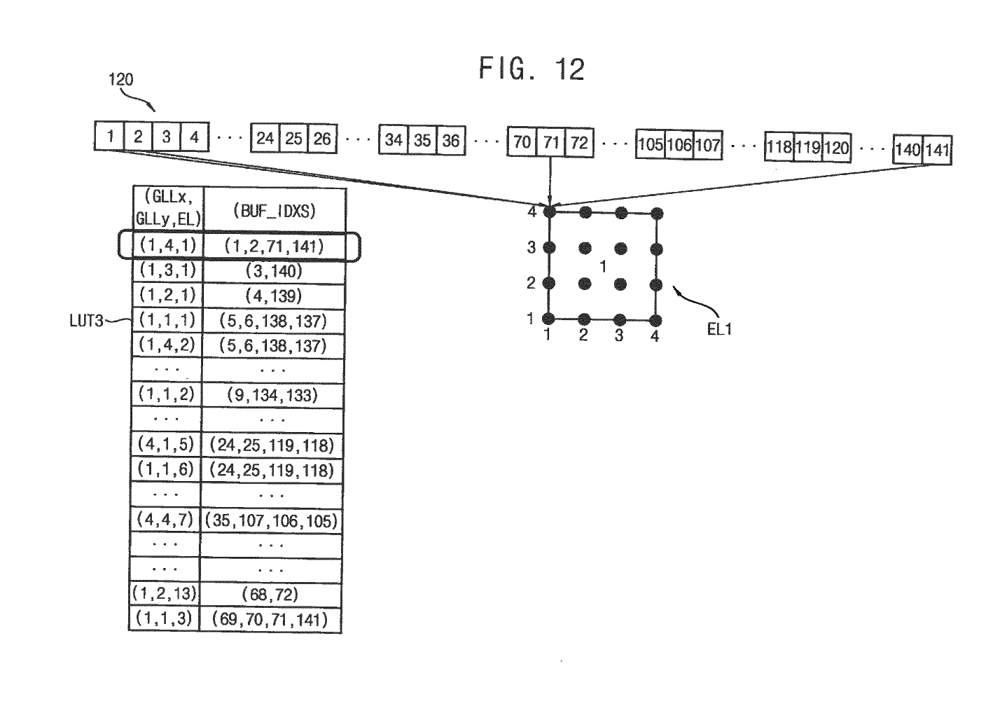

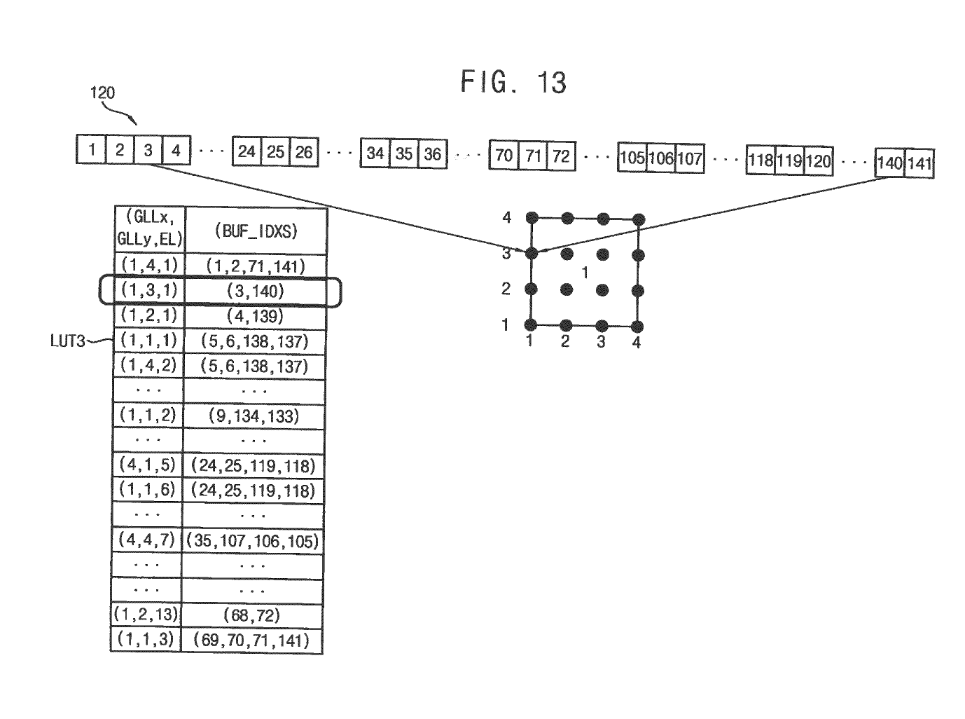

FIG. 12 is a block diagram illustrating a multi-valued GLL-point in an element at group boundary and a third look-up table with a communication buffer in a hardware device according to an example embodiment of the invention. FIG. 13 is a block diagram illustrating another multi-valued GLL-point in the element at group boundary and the third look-up table of FIG. 12.

Referring to FIG. 12, a multi-valued GLL-point may include a plurality of grid values in elements adjacent to each other. For example, a GLL-point having coordinates of (1, 4, 1) in a 1st element ELI may include four grid values in four elements which are adjacent to each other. In this case, a third look-up table LUT3 may be configured to store a plurality of buffer indices of the four grid values in the four elements. For example, the third look-up table LUT3 may be configured to store a pair of number one, number two, number seventy-one and number one hundred forty-one among buffer indices in a communication buffer 120 along with the coordinates of (1, 4, 1).

Referring to FIG. 13, for example, a GLL-point having coordinates of (1, 3, 1) in the 1sth element may include two grid values in two elements which are adjacent to each other. In this case, the third look-up table LUT3 may be configured to store a pair of number three and number one hundred forty among buffer indices in the communication buffer 120 along with the coordinates of (1, 3, 1).

As mentioned above, a look-up table may be configured to store buffer indices of multi-valued GLL-points along with corresponding coordinates, thereby easily referring to buffer indices of a communication buffer without reading each of the grid values one by one in order to send or receive grid values in elements at the group boundaries. Accordingly, a process time for a communication between elements at group boundaries may decrease.

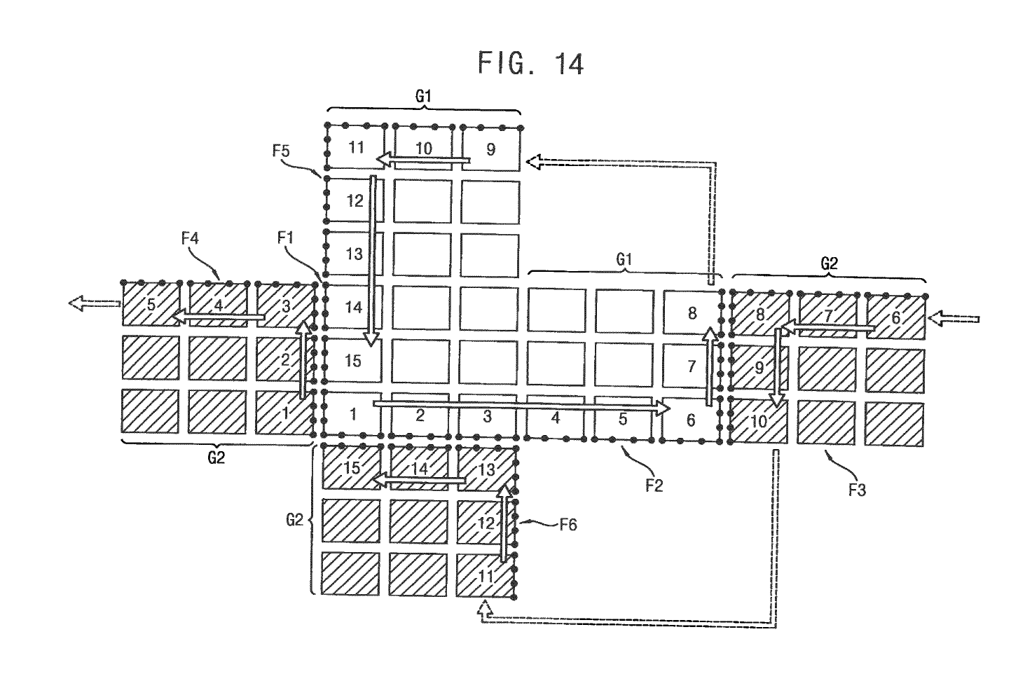

FIG. 14 is a plan view illustrating elements categorized into two groups in an element computation-communication parallelization method implemented on cubed-sphere grids based on a spectral element method according to example embodiment of the invention.

Referring to FIG. 14, a cubed-sphere according to the present example embodiment may include six faces F1, F2, F3, F4, F5 and F6 which have nine elements arranged in a 3×3 matrix shape respectively. For example, the cubed-sphere may include fifty-four elements in total. The elements on the cubed-sphere may be categorized into two groups, e.g., a first group G1 and a second group G2. The first group G1 may be within a first face F1, a second face F2 and a fifth face F5. The second group G2 may be within a third face F3, a fourth face F4 and a sixth face F6.

In the present example embodiment, indices of elements at group boundaries may be consecutive in a desired direction within each of the first group G1 and the second group G2. For example, the elements at group boundaries in the first group G1 and the second group G2 may be consecutive in a counterclockwise direction on a cubed-sphere. For example, indices of the elements in the first group G1 may have a consecutively growing sequence from an element at lower left in the first face F1 to an element at middle left in the first face F1 in the counterclockwise direction on the cubed-sphere. For example, indices of the elements in the second group G2 may have a consecutively growing sequence from an element at lower right in the fourth face F4 to an element at upper left in the sixth face F6 in the counterclockwise direction on the cubed-sphere.

Although boundary points of elements at group boundaries communicated between the first group G1 and the second group G2 are illustrated in FIG. 14, inner points and other boundary points of each of the elements are omitted for ease of description. Although the elements in the first group G1 and the second group G2 include GLL-points arranged in a 4×4 matrix shape, a number of the GLL-points in each of the elements may be various according to example embodiments.

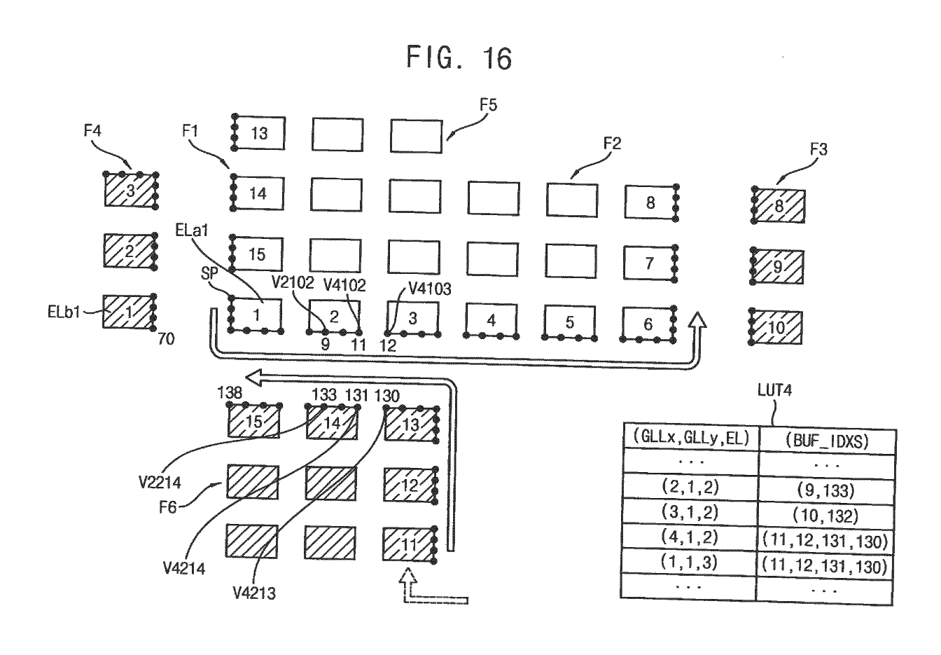

A number of the boundary points of the elements at group boundaries communicated between the first group G1 and the second group G2 may be sixty-nine in FIG. 14. The sixty-nine boundary points may have a desired order in each of the first group G1 and the second group G2, which will be further described in detail referring to FIG. 16.

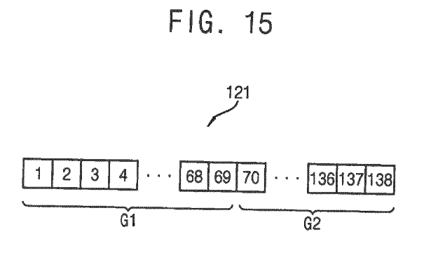

FIG. 15 is a block diagram illustrating a buffer memory in a hardware device which may be used in the element computation-communication parallelization method of FIG. 14.

Referring to FIG. 14 and FIG. 15, a communication buffer 121 may be used to communicate grid values at the boundary points of the elements at group boundaries between the first group G1 and the second group G2. The communication buffer 121 may include a first buffer indices corresponding to grid values at the sixty-nine boundary points of the first group G1 and a second buffer indices corresponding to grid values of the sixty-nine boundary points of the second group G2. For example, number one through number sixty-nine among buffer indices of the communication buffer 121 may correspond to the grid values at the sixty-nine boundary points of the first group G1. For example, number seventy through number one hundred thirty-eight among buffer indices of the communication buffer 121 may correspond to the grid values at the sixty-nine boundary points of the second group G2.

FIG. 16 is a plan view illustrating multi-valued GLL-points with a fourth look-up table corresponding to the buffer memory of FIG. 15.

Referring to FIG. 15 and FIG. 16, in the present example embodiment, GLL-points of the first group G1 communicating with boundary points of elements at group boundary of the second group G2 may have a desired order in a clockwise or counterclockwise direction on a cubed-sphere. For example, the GLL-points of the first group G1 communicating with the second group G2 may have an order from a start point SP having coordinates of (1, 4, 1) in a first element ELa1 of the first group G1 in a counterclockwise direction on the cubed-sphere.

Similarly, GLL-points of the second group G2 communicating with the first group G1 may have an order from a GLL-point having coordinates of (4, 1, 1) in a first element ELb1 of the second group G2 in a counterclockwise direction on the cubed-sphere. In this case, buffer indices of the communication buffer 121 may correspond to the orders of the first group G1 and the second group G2. For example, a grid value V2102 at coordinates of (2, 1, 2) of a second element of the first group G1 (i.e., a GLL-point having a numeral 9) may be stored in number nine among the buffer indices. For example, a grid value V4102 at coordinates of (4, 1, 2) of the second element of the first group G1 (i.e., a GLL-point having a numeral 11) may be stored in number eleven among the buffer indices. For example, a grid value V4103 at coordinates of (1, 1, 3) of a third element of the first group G1 (i.e., a GLL-point having a numeral 12) may be stored in number twelve among the buffer indices. Similarly, a grid value at coordinates of (4, 1, 1) of the first element ELb1 of the second group G2 (i.e., a GLL-point having a numeral 70) may be stored in number seventy among the buffer indices. A grid value V4213 at coordinates of (1, 4, 13) of a thirteenth element of the second group G2 (i.e., a GLL-point having a numeral 130) may be stored in number one hundred thirty among the buffer indices. A grid value V4214 at coordinates of (4, 4, 14) of a fourteenth element of the second group (32 (i.e., a GLL-point having a numeral 131) may be stored in number one hundred thirty-one among the buffer indices. A grid value V2214 at coordinates of (2, 4, 14) of the fourteenth element of the second group G2 (i.e., a GLL-point having a numeral 133) may be stored in number one hundred thirty-three among the buffer indices. A grid value at coordinates of (1, 4, 15) of a fifteenth element of the second group G2 (i.e., a GLL-point having a numeral 138) may be stored in number one hundred thirty-eight among the buffer indices. As mentioned above, boundary points of elements at group boundaries communicating between groups may have a desired order, and grid values at the boundary points communicating between the groups may be stored in buffer indices corresponding to the desired order. A fourth look-up table LUT4 may store the boundary points and their corresponding buffer indices to store the grid values. Accordingly, grid values at boundary points of elements at group boundaries may be communicated with each other using the fourth look-up table LUT4, thereby easily referring to buffer indices in a communication buffer without reading each of the grid values in another group one by one. Accordingly, a process time for a communication between elements at group boundaries may decrease.

As mentioned above, according to one or more example embodiment of the element computation-communication parallelization method implemented on cubed-sphere grids based on a spectral element method and the hardware device performing the same, the elements of the spectral element method may be categorized into elements within a group and elements at group boundary, and a computation of the elements within the group may be simultaneously performed with a communication between the elements at the group boundary, thereby reducing a processing time to compute and communicate the elements of the spectral element method in cubed-sphere grids.

Also, the communication between the elements at the group boundary may be performed by using a predetermined look-up table, and a dimension of a communication buffer may be adequately adjusted, thereby reducing a computational complexity to apply a variety of dynamic conditions of the atmosphere without an additional parallelization information table.

The foregoing is illustrative of example embodiments and is not to be construed as limiting thereof. Although a few example embodiments have been described, those skilled in the art will readily appreciate that many modifications are possible in example embodiments without materially departing from the novel teachings and advantages of the present invention. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

[EXPLANATION ON REFERENCE NUMERALS]

| | |
|---|---|
| 100: hardware device | 110: memory |
| 115: look-up table | 120, 121: communication buffer |
| 130: computation part | EL: element |
| F1, F2, F3, F4, F5, F6: face | |
| G1, G2: group of elements | |

What is claimed is:

1. A method of parallelizing computation in an element and communication between elements in a cubed-sphere coordinates system based on a spectral element method, wherein the method performed in a hardware device comprising a computation part, a memory and a communication buffer electrically connected to the computation part and the memory, the computation part comprising a plurality of computing units, and the method comprising:
categorizing a plurality of elements into one of a first group and a second group, the second group being communicated with the first group;
categorizing the elements in the first group and the second group into one of an element within group and an element at group boundary, the element at group boundary being communicated with one of the elements in the other group to which the element at group boundary does not belong;
computing a first grid value at a first grid point in a first element among elements within group of the first group according to a predetermined numerical equation; and
sending or receiving both of a second grid value at a second grid point in a second element and a third grid value at a third grid point in a third element via the communication buffer, the second element being among elements at group boundary of the first group, the third element being among elements at group boundary of the second group,
wherein the computing the first grid value at the first grid point in the first element is performed substantially at the same time as the sending or receiving both of the second grid value at the second grid point in the second element and the third grid value at the third grid point in the third element via the communication buffer.

2. The method of claim 1, wherein the elements at group boundary of the first group have a sequential order in a clockwise or counterclockwise direction on a cubed-sphere.

3. The method of claim 1, wherein at least one of the second grid value and the third grid value corresponds to a first buffer index of the communication buffer by a predetermined look-up table.

4. The method of claim 1, wherein grid values at boundary points in the elements at group boundary of the first group communicating with the second group correspond to consecutive buffer indices of the communication buffer in a clockwise or counterclockwise direction on a cubed-sphere.

5. The method of claim 1, wherein the second element comprises a first boundary point having at least two grid values.

6. The method of claim 5, wherein the first boundary point of the second element correspond to a second buffer index of the communication buffer by a predetermined look-up table, and the second buffer index refers to the at least two grid values.

7. A hardware device comprising:
a computation part configured to categorize a plurality of elements in a cubed-sphere coordinates system based on a spectral element method into one of a first group and a second group, categorize the elements in the first group and the second group into one of an element within group and an element at group boundary, and compute a first grid value at a first grid point in a first element among elements within group of the first group according to a predetermined numerical equation, wherein the second group communicates with the first group, and the element at group boundary communicates with one of the elements in the other group to which the element at group boundary does not belong; and
a communication buffer configured to send or receive both of a second grid value at a second grid point in a second element and a third grid value at a third grid point in a third element substantially at the same time as the computation part computes the first grid value at the first grid point in the first element, wherein the second element is among elements at group boundary of the first group, and the third element is among elements at group boundary of the second group.

8. The hardware device of claim 7 further comprising:
a memory comprising a look-up table which stores a first buffer index of the communication buffer,
wherein the first buffer index corresponds to the second grid value or the third grid value.

9. The hardware device of claim 7, wherein the second element comprises a first boundary point having at least two grid values.

10. The hardware device of claim 9 further comprising:
a memory comprising a look-up table which stores a second buffer index of the communication buffer,
wherein the first boundary point of the second element correspond to the second buffer index, and the second buffer index refers to the at least two grid values.
